(19) United States
(12) Patent Application Publication
(10) Pub. No.: US 2006/0061477 A1
(43) Pub. Date: Mar. 23, 2006

(54) Warning and monitoring device

(76) Inventor: Ming-Hsiang Yeh, Taipei City (TW)

Correspondence Address: TROXELL LAW OFFICE PLLC, 5205 LEESBURG PIKE, SUITE 1404, FALLS CHURCH, VA, 22041, US

(21) Appl. No.: 10/945,883

(22) Filed: Sep. 22, 2004

(51) Int. Cl. G08B 23/00; G08B 21/00

(52) U.S. Cl. 340/573.5; 340/604

(57) ABSTRACT

A warning and monitoring device is composed of a control case and several detectors. The control case comprises a central processor, a microphone, a speaker, and several function buttons, wherein these detectors are humidity detectors and are extended outside of the control case through an electric cord. Therefore, the control case is able to connect to a diaper by putting the detectors on the inside of the diaper. If the detectors detect a signal, the speaker will send out a notification to inform the watcher to replace the diaper timely so as to offer the user continuous dryness and comfort.

### BACKGROUND OF THE INVENTION

The present invention relates to a warning and monitoring device, and more particularly to a device that is coupled with article for daily use, for example, diaper, clothes, or the like, and is suitable to baby or incapacity people.

Before a newborn baby can talk and walk, his parents must provide all life essentials for him. For example, the diaper is replaced if his parents find that the diaper is wet after the diaper is examined frequently. Alternatively, the diaper is replaced when the baby's parents are notified by his crying over uncomfortable feeling due to the heavy wet diaper, however, the young and delicate skin of the bay will suffer from eczema. Similarly, the person who is confined to bed for a long term occurs the identical circumstance.

In order to cure the aforementioned deficiencies, one type of diaper that is capable of notifying the watcher to replace the diaper is therefore provided. In this diaper, a color changeable region is formed on the outside of the diaper. When the diaper gets wet, the color of the color changeable region mounted on the outside of the diaper will be changed so as to notify the watcher. In this way, however, the watcher has to observe that whether the color is changed, if the watcher is handling a task in other place and cannot observe the color change timely, then the color change will not be observed by the watcher until he comes over. Accordingly, another type of diaper is provided.

As disclosed in publication No. 422,088, entitled “Diaper with urination or excretion notification device”, an absorber is sandwiched between a surface layer and a water proof layer, and is located on the central portion of a top end of the water proof layer. The urination notification device includes a controller, which is capable of sending out a sound or generating a light to notify bystander, characterized in that in the urination notification device two conductive flat metal foils acting as sensors are sandwiched between the water proof layer and the absorber. The outside part of these two conductive flat metal foils are extended away from the front side-edge of the paper diaper so as to connect to the controller. These two conductive flat metal foils are electrically connected to each other so as to trigger the controller if the paper diaper gets wet due to urination.

However, in the process of fabricating the above diaper, an additional step is involved to mount two conductive flat metal foils acting as sensors on a position between the water proof layer and the absorber, and the outside part of these two conductive flat metal foils are extended away from the front side-edge of the paper diaper so as to connect to the controller. In this way, however, the controller must comply with the diaper. The controller is useless if the corresponding paper diaper is replaced by another brain of diaper.

Whereas the aforementioned deficiencies of the conventional structures in want of improvement, the motive of the present invention is to provide a warning and monitoring device that can be used together with other brain of diaper. Accordingly, the present inventor has been made diligent studies with a quiet mind to design and fabricate a warning and monitoring device and to provide thereof for the consumer.

### SUMMARY OF THE INVENTION

The main purpose of the present invention is to provide a warning and monitoring device, which is able to couple with various commercial paper diapers for use, wherein it is not necessary to change the process of fabricating the diaper.

Another purpose of the present invention is to provide a warning and monitoring device, wherein the mother's sound can be pre-recorded such that an interaction is performed when the watcher is notified and the baby is pacified by hearing the mother's sound.

It is still another purpose of the present invention to provide a warning and monitoring device on which a camera lens are mounted for transmitting the environmental condition surrounding the baby, who is capable of crawling, to the monitor such that the watcher is able to keep the baby under control.

According to the aforementioned purposes of the present invention, a warning and monitoring device, which is composed of a control case and several detectors, is provided. The control case comprises a central processor, a microphone, a speaker, and several function buttons, wherein these detectors are humidity detectors and are extended outside of the control case through an electric cord. Therefore, the control case is able to couple with a diaper by putting the detectors on a position between the diaper and the user's body. If the detectors detect a signal, the speaker will send out a notification to inform the watcher to replace the diaper timely so as to offer the user continuous dryness and comfort.

The aforementioned aspects and advantages of the present invention will be readily clarified in the hereafter description of examples of preferred embodiments of the present invention, in reference with the enclosed drawings.

### BRIEF DESCRIPTION OF THE DRAWINGS

FIG. 1 is a perspective view showing an outward appearance of a preferred embodiment of the present invention.

FIG. 2 is a circuit block diagram of a control case in accordance with the present invention.

FIG. 3 is a schematic diagram showing the use of the preferred embodiment of the present invention.

FIG. 4 is a perspective view showing an outward appearance of a second preferred embodiment of the present invention.

### DETAILED DESCRIPTION OF THE PREFERRED EMBODIMENT

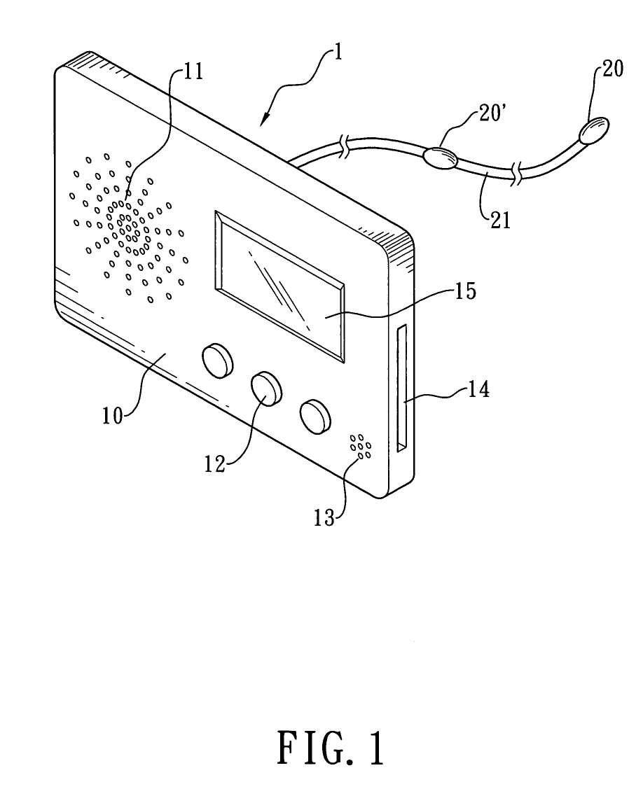

As shown in FIG. 1, a warning and monitoring device 1 in accordance with the present invention comprises a control case 10 with a proper size. A speaker 11, a monitor 15, several function buttons 12 (such as recording button, playing button, etc), a microphone 13, and a memory slot 14 are mounted on the control case 10. In addition, two detectors 20, 20′ are mounted away from the control case 10 through an electric cord 21. These two detectors 20, 20′ (the first detector 20 and the second detector 20′) spacing in a proper distance are humidity detectors.

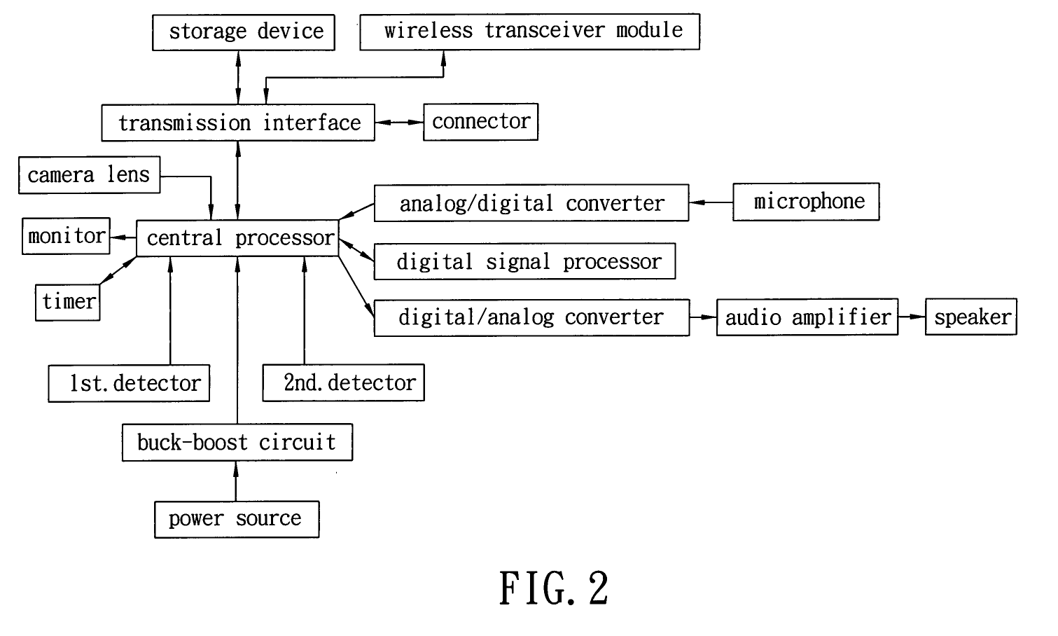

As shown in FIG. 2, a control circuit having a central processor is mounted within the control case 10, wherein the central processor is integrated with the speaker, the microphone, two detectors, a timer, and the monitor through an analog/digital converter, a digital signal processor, and a digital/analog converter. Optionally, a camera lens is mounted thereon. The central processor is connected to a storage device (such as memory card), a wireless transceiver module, and a connector (such as USB) through a transmission interface.

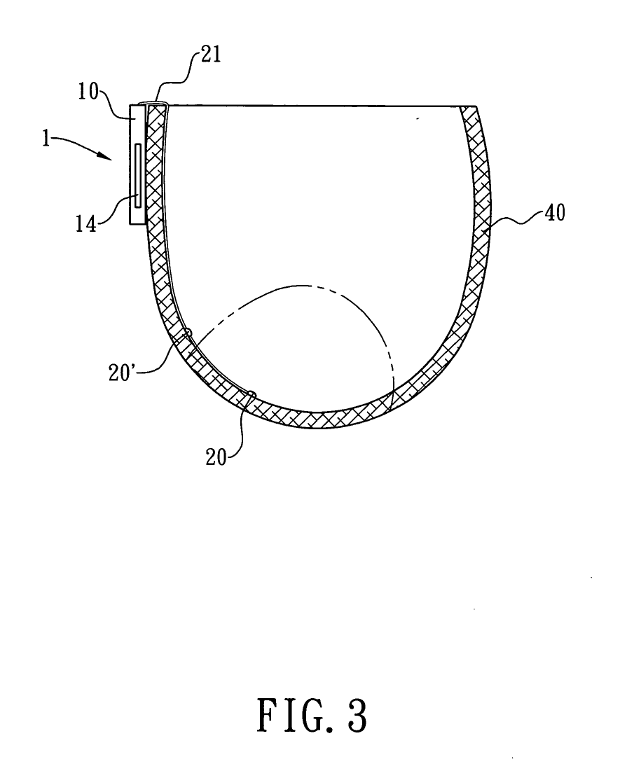

For example, if the present invention is applied to a little baby, the mother's talk, for example, “Good baby, mother will check it for you right now”, or “Oh, baby, you have too much urine, it is almost full, mother will replace it for you right away” can be pre-recorded into a memory card through the microphone 13. Besides, the functional buttons 12 can be used to set, for example, the speaker 11 will send out “Good baby, mother will check it for you right now” when the signal is detected by the first detector 20, and “Oh, baby, you have too much urine, it is almost full, mother will replace it for you right away” will be sent out when the signal is detected by the second detector 20. A shown in FIG. 3, a binder (not shown) for binding the control case 10 on the outside of the front end of a paper diaper 40 is mounted on the backside of the control case 10. The electric cord 21 having two detectors 20, 20′ mounted thereon is lengthened into the inside of the paper diaper 40. After the bottom of the baby is put on the paper diaper 40, the paper diaper 40 is then wrapped up. Consequentially, the mother is able to know the condition of the baby according to the warning talk sent out from the speaker 11 of the control case 10, and the baby can be pacified by means of the mother's sound sent out from the speaker 11 such that the timely communication is made for more rapidly developing the baby's mind.

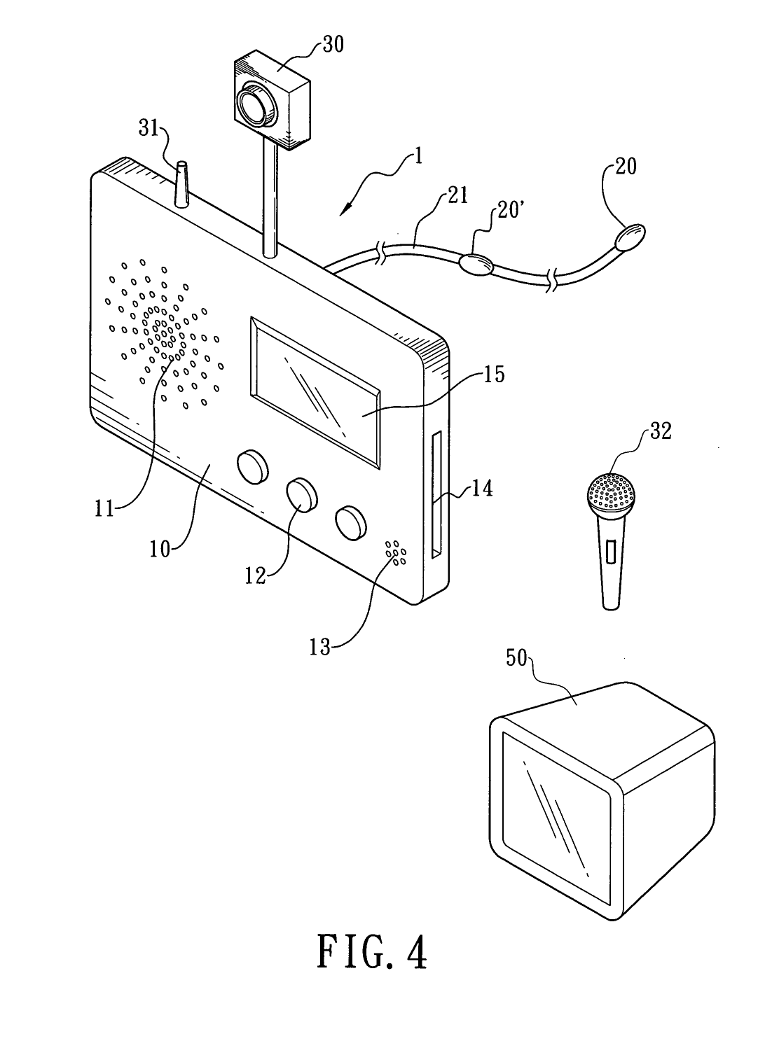

Referring to FIG. 4, a camera lens 30 is connected to the control case 10 through a flexible strip and an antenna 31 is mounted on the outside of the control case 10 for transmitting the images captured by the camera lens 30 to a monitor 50 in a wireless way. In this way, the watcher carries a wireless microphone 32 and puts the monitor 50 on an observable location, when the watcher cannot keep with the user. In addition, the control case 10 is coupled with the user such that the environmental condition surrounding the user can be known by means of the capturing of the camera lens 30 and the showing of the monitor 50. When the user has any improper behavior, the watcher can use the microphone 32 to stop the user by making sound, and reach the place that the user are located. Moreover, the control case 10 can edit and store the date file of the images by connecting to a computer through a connector.

It is apparent that the apparatus of the present invention comprises the following advantages:

1. The humidity degree of the paper diaper can be realized by means of the sense of hearing without relying on the tactile sense and vision. In addition, the purpose for pacifying can be achieved through the pre-recorded talk such that the further interactive purpose can be accomplished.

2 The present invention is an independent individuality. Since it is not necessary to couple with a specific brand of paper diaper, it does not affect the fabricating process of the paper diaper. Thus, the present invention is able to couple with any brand of paper diaper.

3. The environmental condition surrounding the user can be transmitted to the monitor for being shown on the monitor by using the camera lens of the present invention. Thus, the watcher is able to realize the environmental condition surrounding the user through the monitor. When the user has any improper behavior, the watcher is able to stop this improper behavior through the wireless microphone.

The foregoing preferred embodiments of the present invention are illustrated of the present invention rather than limiting of the present invention. It is intended that various modifications and similar arrangements be included within the spirit and scope of the appended claims.

As described above, the present invention discloses a warning and monitoring device, which complies with requirements, and is therefore submitted for a patent application.

What the invention claimed is:

1. A warning and monitoring device comprising:
a control case, wherein a central processor, a speaker, a microphone, a plurality of function buttons, a monitor, and a storage device are mounted on the control case; and
at least a detector, wherein the detector is a humidity detector and is connected to the control case through an electric cord,
wherein the control case is able to couple with a diaper by putting the detector on the inside of the diaper, and if the detector detects a signal, the speaker will send out a pre-recorded sound to inform the timing for replacing the diaper.

2. The warning and monitoring device of claim 1, wherein a binder is mounted on the backside of the control case for coupling with the diaper.

3. The warning and monitoring device of claim 1, wherein a camera lens is connected to the control case through a flexible strip and a wireless transmission device is mounted on the control case for transmitting an image to the monitor.

4. The warning and monitoring device of claim 1, wherein a connector is mounted on the control case.

5. The warning and monitoring device of claim 1, wherein a storage device is a memory card.
